(19) United States
(12) Patent Application Publication
(10) Pub. No.: US 2007/0260691 A1
(43) Pub. Date: Nov. 8, 2007

(54) Wireless local area network capacity triggered upload and download

(76) Inventors: Claes M. Kallqvist, Lund (SE); Ramsten Fredrik, Malmo (SE); Malin Andersson, Manchester (GB)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/415,773

(22) Filed: May 2, 2006

(51) Int. Cl. G06F 15/16

(52) U.S. Cl. 709/206

(57) ABSTRACT

Disclosed is electronic equipment (e.g., a mobile telephone) and method directed to electronic equipment having an improved electronic mail (E-mail) application for transmitting and/or sending E-mail messages based on one or more characteristics of the E-mail message (e.g., file size). In one embodiment, the user implements a network communication priority list in which the E-mail application utilizes to transmit/receive E-mail messages. In another embodiment the user may specify that E-mail message below a certain threshold value be transmitted through a first communication network (e.g. cellular telephone network) and a second communication network (e.g. LAN/WLAN network) when the E-mail messages are above the threshold limit.

### TECHNICAL FIELD OF THE INVENTION

The present invention relates to a method and apparatus for transmitting and/or receiving electronic mail (E-mail) messages using electronic equipment.

### DESCRIPTION OF THE RELATED ART

In recent years, electronic mail (“E-mail”) has become a prevalent form of communication. Because E-mail is typically fast, convenient, and easy to use, E-mail has become a popular media for communications in both business and personal settings. Electronic equipment, such as, for example, communication devices, mobile phones, personal digital assistants, etc. may include an E-mail application that allows the user to send and receive E-mail messages to and from others.

The E-mail application is typically a computer readable media in the form of executable code that may be stored in memory of the electronic equipment. Conventional E-mail applications generally do not include advanced send/receive E-mail parameters based on physical attributes associated with the E-mail message. Such physical attributes may include, for example, length of message, size of an attachment, type of attachment, etc. Conventional E-mail applications allow a user to send an E-mail message substantially immediately from the user's electronic equipment to the connected network when the user presses a send/transmit key or allows the user to place the E-mail message in an outbox for delivery at a later time if the network is unavailable.

The cost for sending E-mail messages over a cellular telephone infrastructure is generally much more expensive than sending an E-mail message over a local area network (LAN) and/or wireless local area network (WLAN). Conventional E-mail applications can be defined to use different data bearers like, for example, GPRS, WLAN, etc. using a priority list. When the device cannot find the first option in the list of data bearers the selection process advances to the second option and so on, till the end of the list.

One drawback with conventional E-Mail applications is that the user is not provided with a mechanism that allows the user to send and/or receive an E-mail message based on the physical attributes of the message. Thus, for example, a cost aware user cannot send an E-mail message when the rate it is the cheapest possible or select the fastest network for upload and download services based on the size of E-mail message.

### SUMMARY

In view of the aforementioned shortcomings associated with conventional E-Mail applications, there is a strong need in the art for an E-mail application that allows the user to specify a preferred communication network (e.g. GPRS, WLAN, etc.) for receiving and/or transmitting E-mail messages based on physical attributes of the message.

One aspect of the invention relates to a method for transmitting an electronic mail message in a mobile telephone, the method comprising: determining a file size associated with an E-mail message; selecting a communication network to transmit the E-mail message based at least on part on the file size of the E-mail message, wherein a first communication network is selected when the file size is below a threshold file size and a second communication network is selected when the file size is above the threshold file size; and transmitting the E-mail message to the selected communications network for delivery to an associated remote E-mail server.

Another aspect of the invention relates to the first communication network being a cellular telephone network.

Another aspect of the invention relates to the second communication network being a local area network.

Another aspect of the invention relates to the second communication network being a wireless local area network.

Another aspect of the invention relates to further including manually selecting the threshold file size.

Another aspect of the invention relates to the threshold file size being a predetermined default file size.

Another aspect of the invention relates to selecting a communication network based on a priority list of communication networks.

Another aspect of the invention relates to the priority list being formed by an associated user assigning a priority to a plurality of available communication networks.

Another aspect of the invention relates to when the E-mail message has not been transmitted for a user defined time period, another communication network is selected from the priority list to transmit/receive the E-mail message.

Another aspect of the invention relates to a mobile telephone comprising: an electronic mail (E-mail) application stored in a memory of the mobile telephone, wherein the E-mail application is configurable for transmitting an E-mail message in a first mode when the E-mail message has a file size less than a threshold file size and a second mode when the file size of the E-mail message is greater than the threshold file size. a processor coupled to the E-mail application, wherein the processor compares the file size of the E-mail message with the threshold file size and configures the mobile telephone for communication using the first mode or the second mode.

Another aspect of the invention relates to further including a display coupled to the processor for displaying a status of at least one function associated with the E-mail application.

Another aspect of the invention relates to the associated user selecting the threshold file size.

Another aspect of the invention relates to the threshold file size being a predetermined file size.

Another aspect of the invention relates to the first mode being a cellular telephone network.

Another aspect of the invention relates to the second mode being a local area network.

Another aspect of the invention relates to the second mode being a wireless local area network.

Another aspect of the invention relates to a method for transmitting an electronic mail message in a mobile telephone, the method comprising: determining a file size of an E-mail message; selecting a communication network to transmit the E-mail message by an associated user based at least on part on a network priority list stored in a memory of a mobile telephone, wherein the network priority list includes a plurality of networks the file size of the E-mail message, wherein a first communication network is selected when the file size is below a threshold file size and a second communication network is selected when the file size is above the threshold file size; and transmitting the E-mail message to the selected communications network for delivery to an associated remote E-mail server.

Another aspect of the invention relates to A method for receiving an electronic mail message in a mobile telephone, the method comprising: determining a file size associated with an E-mail message; selecting a communication network to receive the E-mail message based at least on part on the file size of the E-mail message, wherein a first communication network is selected when the file size is below a threshold file size and a second communication network is selected when the file size is above the threshold file size; and receiving the E-mail message from an associated remote E-mail server through the selected communications network.

Another aspect of the invention relates to a method for transmitting an electronic mail message in a mobile telephone, the method comprising: determining a file size of an E-mail message; selecting a communication network to receive the E-mail message by an associated user based at least on part on a network priority list stored in a memory of a mobile telephone, wherein the network priority list includes a plurality of networks the file size of the E-mail message, wherein a first communication network is selected when the file size is below a threshold file size and a second communication network is selected when the file size is above the threshold file size; and receiving the E-mail message from an associated remote E-mail server through the selected communications network.

Another aspect of the invention relates to a method for transmitting an electronic mail message in a mobile telephone, the method comprising: determining a file size of an E-mail message; querying an associated user to select a communication network to receive and/or transmit the E-mail message, wherein the associated user may select either a cellular telephone network or a local area network for transmission of the E-mail message; transmitting the E-mail message through the selected communications network for delivery to an associated remote E-mail server.

Another aspect of the invention relates to a computer program stored on a machine readable medium, the program being suitable for use in an electronic equipment as an electronic mail application, wherein: when the program is loaded in memory in the electronic equipment and executed causes the electronic equipment to transmit and/or receive an E-mail message from a cellular telephone network and/or a local area network based at least in part on the file size of the E-mail message.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

It should be emphasized that the term “comprise/comprising” when used in this specification is taken to specify the presence of stated features, integers, steps or components but does not preclude the presence or addition of one or more other features, integers, steps, components or groups thereof.”

The term “electronic equipment” includes portable radio communication equipment. The term “portable radio communication equipment”, which herein after is referred to as a mobile radio terminal, includes all equipment such as mobile telephones, pagers, communicators, i.e., electronic organizers, personal digital assistants (PDA's), portable communication apparatus, smart phones or the like.

### BRIEF DESCRIPTION OF THE DRAWINGS

The foregoing and other embodiments of the invention are hereinafter discussed with reference to the drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIGS. 1 and 2 are exemplary schematic diagrams illustrating electronic equipment in accordance with aspects of the present invention.

FIGS. 3 and 4 are exemplary illustrations of an electronic mail application in accordance with aspects of the present invention.

FIG. 5 is an exemplary system in accordance with aspects of the present invention.

FIGS. 6 and 7 are flow charts illustrating exemplary methods in accordance with aspects of the present invention.

### DETAILED DESCRIPTION OF EMBODIMENTS

The present invention is directed to electronic equipment 10, sometimes referred to herein as a communication device, mobile telephone, and portable telephone having an improved electronic mail (E-mail) application for transmitting and/or receiving E-mail messages. In one aspect of the invention, additional functionality over conventional E-mail applications allows the application to transmit and/or receive E-mail messages from a cellular telephone network (e.g., 3G, GPRS, etc.) and a local area network (LAN) and/or wireless local area network (WLAN) depending on the file size of the E-mail message.

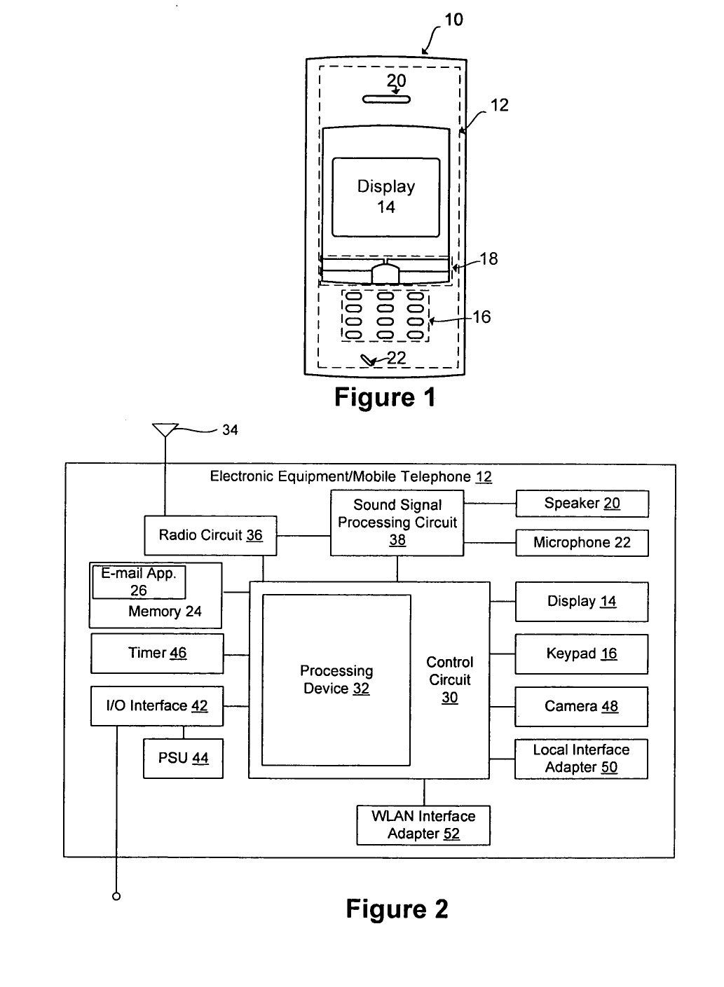

Referring to FIG. 1, electronic equipment 10 is shown in accordance with the present invention. The electronic equipment 10 in the exemplary embodiment is a mobile telephone and will be referred to as the mobile telephone 10. The mobile telephone 10 is shown as having a “brick” or “block” design type housing, but it will be appreciated that other type housings, such as clamshell housing or a slide-type housing, may be utilized without departing from the scope of the invention.

As illustrated in FIG. 1, the electronic equipment 10 may include a user interface 12 (identified by dotted lines) that enables the user easily and efficiently to perform one or more communication tasks (e.g., send an E-mail, display an E-mail, receive an E-mail, identify a contact, select a contact, make a telephone call, receive a telephone call, etc.). The user interface 12 of the electronic equipment 10 generally includes one or more of the following components: a display 14, an alphanumeric keypad 16, function keys 18, a navigation tool 19, a speaker 20, and a microphone 22.

The mobile telephone 10 includes a display 14. The display 14 displays information to a user such as operating state, time, telephone numbers, contact information, various navigational menus, status of one or more functions, etc., which enable the user to utilize the various features of the mobile telephone 10. The display 14 may also be used to visually display content accessible by the mobile telephone 10. The displayed content may include E-mail messages, audio and/or video presentations stored locally in memory 24 (FIG. 2) of the mobile telephone 10 and/or stored remotely from the mobile telephone 10 (e.g., on a remote storage device, a mail server, remote personal computer, etc.). Such presentations may be derived, for example, from multimedia files received through E-mail messages, including audio and/or video files, from a received mobile radio and/or television signal, etc. The audio component may be broadcast to the user with a speaker 20 of the mobile telephone 10. Alternatively, the audio component may be broadcast to the user though a headset speaker (not shown).

The mobile telephone 10 further includes a keypad 16 that provides for a variety of user input operations. For example, the keypad 16 may include alphanumeric keys for allowing entry of alphanumeric information such as E-mail addresses, distribution lists, telephone numbers, phone lists, contact information, notes, etc. In addition, the keypad 16 typically may include special function keys such as a “call send” key for transmitting an E-mail, initiating or answering a call, and a “call end” key for ending, or “hanging up” a call. Special function keys may also include menu navigation keys, for example, for navigating through a menu displayed on the display 14 to select different telephone functions, profiles, settings, etc., as is conventional. Other keys associated with the mobile telephone 10 may include a volume key, audio mute key, an on/off power key, a web browser launch key, an E-mail application launch key, a camera key, etc. Keys or key-like functionality may also be embodied as a touch screen associated with the display 14.

The mobile telephone 10 includes conventional call circuitry that enables the mobile telephone 10 to establish a call, transmit and/or receive E-mail messages, and/or exchange signals with a called/calling device, typically another mobile telephone or landline telephone. However, the called/calling device need not be another telephone, but may be some other device such as an Internet web server, E-mail server, content providing server, etc.

Referring to FIG. 2, a functional block diagram of the mobile telephone 10 is illustrated. The mobile telephone 10 includes a primary control circuit 30 that is configured to carry out overall control of the functions and operations of the mobile telephone 10. The control circuit 30 may include a processing device 32, such as a CPU, microcontroller or microprocessor. The processing device 32 executes code stored in a memory (not shown) within the control circuit 30 and/or in a separate memory, such as memory 24, in order to carry out operation of the mobile telephone 10. The processing device 32 is generally operative to compare a file size of the E-mail message with a threshold file size and configures the mobile telephone for communication using the first mode or the second mode, as described below.

The memory 24 may be, for example, a buffer, a flash memory, a hard drive, a removable media, a volatile memory and/or a non-volatile memory. In addition, the processing device 32 executes code to carry out various functions of the mobile telephone 10.

Continuing to refer to FIGS. 1 and 2, the mobile telephone 10 includes an antenna 34 coupled to a radio circuit 36. The radio circuit 36 includes a radio frequency transmitter and receiver for transmitting and receiving signals via the antenna 34 as is conventional. The mobile telephone 10 generally utilizes the radio circuit 36 and antenna 34 for voice and/or E-mail communications over a cellular telephone network. The mobile telephone 10 further includes a sound signal processing circuit 38 for processing the audio signal transmitted by/received from the radio circuit 36. Coupled to the sound processing circuit 38 are the speaker 20 and a microphone 22 that enable a user to listen and speak via the mobile telephone 10 as is conventional. The radio circuit 36 and sound processing circuit 38 are each coupled to the control circuit 30 so as to carry out overall operation.

The mobile telephone 10 also includes the aforementioned display 14 and keypad 16 coupled to the control circuit 30. The mobile telephone 10 further includes an I/O interface 42. The I/O interface 42 may be in the form of typical mobile telephone I/O interfaces, such as a multi-element connector at the base of the mobile telephone 10. As is typical, the I/O interface 42 may be used to couple the mobile telephone 10 to a battery charger to charge a power supply unit (PSU) 44 within the mobile telephone 10. In addition, or in the alternative, the I/O interface 42 may serve to connect the mobile telephone 10 to a wired personal hands-free adaptor, to a personal computer or other device via a data cable, etc. The mobile telephone 10 may also include a timer 46 for carrying out timing functions. Such functions may include timing the durations of calls, generating the content of time and date stamps, etc.

The mobile telephone 10 may include various built-in accessories, such as a camera 48 for taking digital pictures. Image files corresponding to the pictures may be stored in the memory 24. In one embodiment, the mobile telephone 10 also may include a position data receiver (not shown), such as a global positioning satellite (GPS) receiver, Galileo satellite system receiver or the like.

To establish wireless communication with other locally positioned devices, such as the a wireless headset, another mobile telephone, a computer, etc., the mobile telephone 10 may include a local wireless interface adapter 50, such as a Bluetooth adaptor.

To establish wireless communication with other locally positioned devices, such as a wireless local area network, wireless access point and the like, the mobile telephone 10 may further include a wireless local area network interface adapter 52. Preferably, the WLAN adapter 52 is compatible with one or more IEEE 802.11 protocols (e.g., 802.11(a), 802.11(b) and/or 802.11(g), etc.) and allows the mobile telephone 10 to acquire a unique address (e.g., IP address) on the WLAN and communicate with one or more devices on the WLAN, assuming the user has the appropriate privileges and/or has been properly authenticated.

The mobile telephone 10 may also be configured to operate in a wide area communications system (e.g. 3G, GPRS) (not illustrated). The system can include a server or servers for managing calls and/or E-mails placed by and/or destined to the mobile telephone 10, transmitting content (e.g., image files, audio files, video files, etc.) to and/or from the mobile telephone 10 and carrying out any other support functions. The server generally communicates with the mobile telephone 10 via a network and a transmission medium. The transmission medium may be any appropriate device or assembly, including, for example, a communications tower, another mobile telephone, a wireless access point, a satellite, etc. Portions of the network may include wireless transmission pathways.

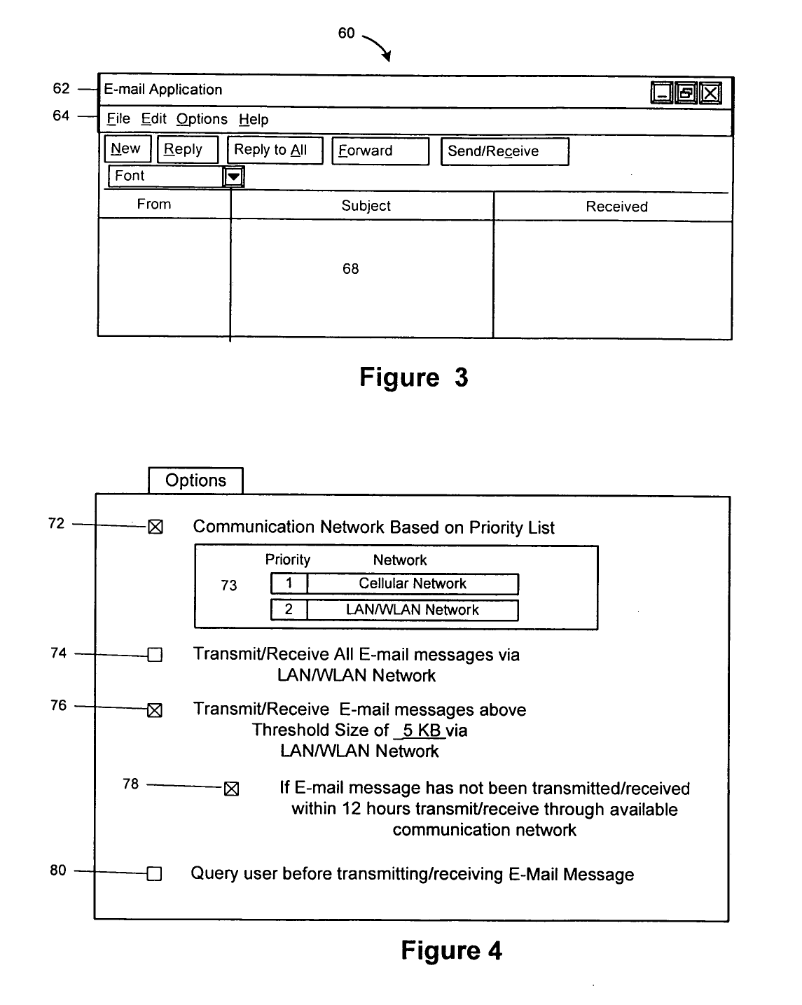

An exemplary electronic mail (E-mail) application 60 in accordance with aspects of the present invention is shown in FIG. 3. The E-mail application 60, as illustrated in FIG. 3, is shown on display 14 of mobile telephone 10. The E-mail application 60 generally includes a title bar 62, menu bar 64, as well as function buttons 66. Exemplary menus for the menu bar 64 include “File”, “Edit”, “Options” and “Help”. Likewise exemplary function button 66 include “New”, “Reply”, “Reply to All”, “Forward” “Send/Receive”. The E-mail application 60 may arrange received and/or transmitted E-mail messages in workspace 68. Workspace 68 generally includes a listing of E-mail messages either sent and/or received organized in a user-defined manner (e.g., when received, when sent, by author, by subject, by attachment size, etc.).

In addition to the conventional fields discussed above, one or more of the following additional user-selectable options may be provided for setting priority information for selecting a communication medium (e.g. GPRS, WLAN, etc.) and/or configuring the E-mail application 60 to select a communication medium based on a physical attribute of the E-mail message to be sent and/or received. In one exemplary embodiment, when the user selects “Options” from the menu bar 64, the user will generally be presented with a dialog box 70 that allows the user to set one or more functions for the E-mail application.

Referring to FIG. 4, an exemplary dialog box 70 is illustrated. The dialog box 70 allows the user to set a variety of communication network rules. For example, at 72, the user is able to set a priority list 73 of networks that the mobile telephone 10 will use to transmit and/or receive E-mail messages. As shown in FIG. 4, the user may set a cellular network as the first priority and a LAN/WLAN network as the next priority. The priority list 73 may include as many networks as the mobile telephone 10 may communicate with. Another feature shown at 74 allows the user to specify that all E-mail messages must be transmitted/received via the LAN/WLAN network.

At 76 the user is presented the ability to transmit/receive messages over a certain file size (e.g. 5 KB) via the LAN/WLAN. When this selection is made, the priority list 73 may be used for controlling which network the smaller messages are transmitted/received. Assuming the user has selected feature 76, if the E-mail message has not been sent within a predetermined time or at a time defined by the user, the user is provided an opportunity to transmit/receive the E-mail message through any available communication network.

At 80, the user may be prompted to decide prior to transmitting/receiving every E-mail message which communication network may be used. Alternatively, the user may be queried which communication network to be used for messages having a file size about a threshold file size.

As shown in FIG. 4, the user has enabled (by placing an “X” in the box associated with the desired feature) the following functionality: E-mail messages should first be transmitted/received from the cellular network. If the cellular network is not available, the LAN/WLAN network should be used. If the file size associated with an E-mail message is larger than 5 KB, then the E-mail message should be transmitted/received from the LAN/WLAN network. If an E-mail message larger than 5 KB has not been transmitted/received within 12 hours, the E-mail message should be transmitted/received through any available communication network.

One of ordinary skill in the art will readily appreciate that there are myriad of features and/or options that can be presented to the user for obtaining the functionality described herein and all such modifications shall be deemed to fall within the scope of the present invention.

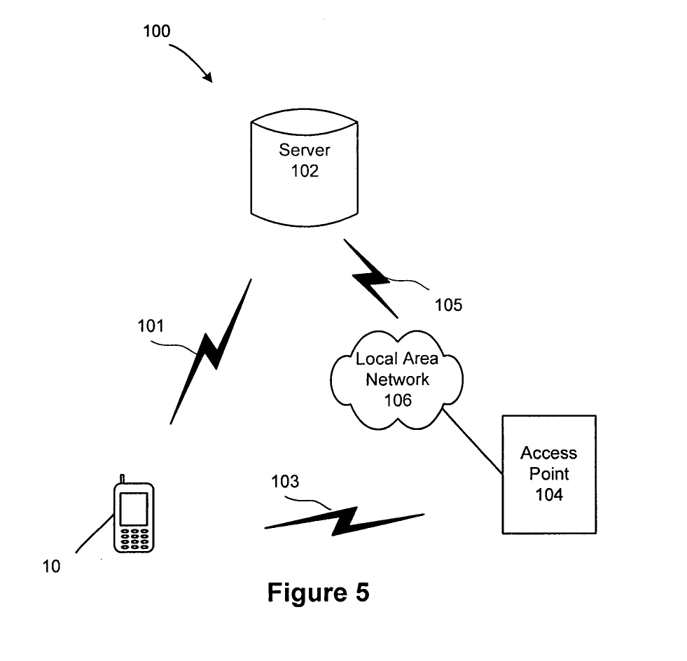

FIG. 5 illustrates an exemplary system 100 in accordance with aspects of the present invention. As shown in FIG. 5, the system 100 includes a cellular telephone link 101 from the mobile telephone 10 to the server 102. Preferably the server 102 is an E-mail server and the user of mobile telephone 10 is a subscriber to such services. Although depicted as a direct communication link from the mobile telephone 10 to the server 102, one of ordinary skill will readily appreciate that the transmission medium for the cellular telephone link 101 may include, for example, one or more communication towers, another mobile telephone, a wireless access point, a satellite, etc.

The system 100 also includes a LAN/WLAN link 103 from the mobile telephone 10 to the wireless access point 104 to LAN 106 and through communication link 105 to the server 102. Mobile telephone 10 is provided with a communications protocol that can be executed by an internal processor of the device and/or by dedicated communications hardware (e.g., a transceiver) coupled to the device for communication with the access point 104. The WLAN adapter 52 of the mobile telephone generally includes a built-in antenna (not shown). The antenna allows the WLAN adapter 52 to exchange signals with the wireless access point 104. The wireless access point 104 generally executes a communication protocol corresponding to the communication protocol executed by the client devices (e.g., device associated with the LAN 106 and/or the mobile telephone 10. The wireless access point 104 also includes communications hardware (e.g., a transceiver with an antenna) for broadcasting signals to the server 102 and various client devices and receiving signals broadcast by server 102 and the various client devices. Although the communication links between the mobile telephone 10 and the access point 104 and between the LAN 106 and the server 102 are depicted as wireless communication links, one of ordinary skill in the art will readily appreciate that such links may be wired, wireless and/or a combination of wired and wireless communication links.

One of ordinary skill in the art will readily appreciate that any communications medium and configuration of network components allowing the functionality described herein shall be deemed to be within the scope of the present invention.

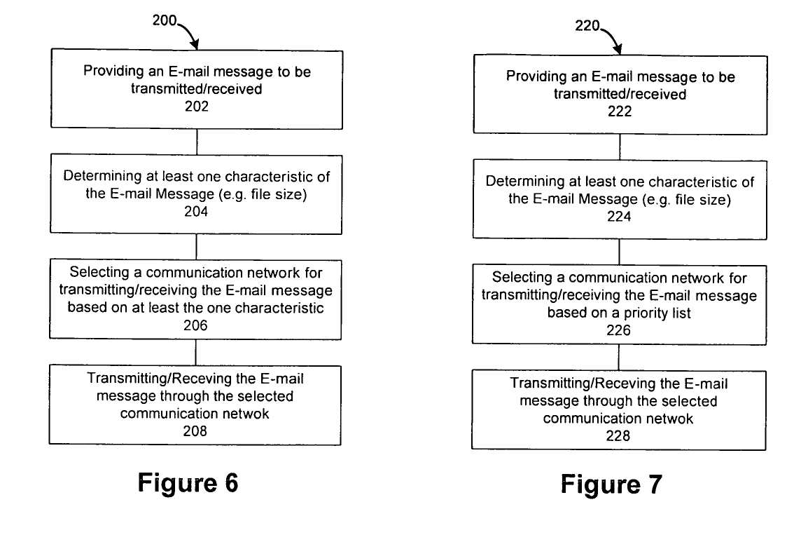

Referring to FIG. 6, an exemplary method 200 for transmitting an E-mail message in a mobile telephone in accordance with aspects of the present invention is illustrated. At step 202, an E-mail message is provided in the mobile telephone 10. The E-mail message may be any type of E-mail message regardless of the source. For example, the E-mail message may be newly created by the user, previously received by the user from a third party, etc. The E-mail message may also include one or more attachments (e.g., documents, multimedia content, songs, video, etc.).

At step 204, at least one characteristic of the E-mail message is determined (e.g. file size, number of lines, number of characters, etc.). Preferably, the file size of the E-mail message is determined. In determining a file size associated with the E-mail message, the entire message including, header, text, attachments, etc. may be used to determine the file size of the E-mail message. The file size may be determined in any manner (e.g., interrogation of the E-mail message header, calculated according to conventional methods, etc.).

At step 206, a communication network for transmission of the E-mail message is selected based at least on part on the file size of the E-mail message. As shown in FIG. 4, generally the user of the mobile telephone 10 may prioritize the communication networks for any desired purpose. Cost may be one reason or basis to prioritize communication networks. (i.e., to prefer one communication network over another communication network) For example, the cost associated with transmitting/receiving all E-mail message from being over the cellular telephone network may be excessive, especially when less costly alternatives exist. Thus, it may be beneficial to transmit and/or receive E-mail messages from a first communication network (e.g., cellular telephone network) when the file size of an E-mail message is below a threshold file size. It may also be beneficial to transmit and/or receive E-mail messages to and from a second communication network (e.g. LAN, WLAN, etc.) when the file size is above the threshold file size. Preferably, the user is given the option of manually selecting the threshold file size. In addition, a default threshold file size may also be provided, which may be based on a predetermined file size.

At step 208, the E-mail message is transmitted and/or received through the selected communications network for delivery to and/or from an associated remote E-mail server.

Referring to FIG. 7, an exemplary method 220 for transmitting an E-mail message in a mobile telephone in accordance with aspects of the present invention is illustrated. At step 222, an E-mail message is provided in the mobile telephone 10. The E-mail message may be any type of E-mail message regardless of the source. For example, the E-mail message may be newly created by the user, previously received by the user from a third party, etc. The E-mail message may also include one or more attachments (e.g., documents, multimedia content, songs, video, etc.).

At step 224, at least one characteristic of the E-mail message is determined (e.g. file size, number of lines, number of characters, etc.). Preferably, the file size of the E-mail message is determined. In determining a file size associated with the E-mail message, the entire message including, header, text, attachments, etc. may be used to determine the file size of the E-mail message.

At step 226, a communication network for transmission of the E-mail message is selected based at least on part on a network communication priority list 73 stored in memory 24. Preferably, the network communication priority list 73 includes a plurality of communication networks. According to aspects of the invention, a first communication network is selected when the file size is below a threshold file size and a second communication network is selected when the file size is above the threshold file size.

At step 228, once the communication network has been selected, the E-mail message is transmitted and/or received through the selected communications network for delivery to and/or from an associated remote E-mail server.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

What is claimed is:

1. A method for transmitting an electronic mail message in a mobile telephone, the method comprising:
determining a file size associated with an E-mail message;
selecting a communication network to transmit the E-mail message based at least on part on the file size of the E-mail message, wherein a first communication network is selected when the file size is below a threshold file size and a second communication network is selected when the file size is above the threshold file size; and
transmitting the E-mail message to the selected communications network for delivery to an associated remote E-mail server.

2. The method of claim 1, wherein the first communication network is a cellular telephone network.

3. The method of claim 2, wherein the second communication network is local area network.

4. The method of claim 2, wherein the second communication network is a wireless local area network.

5. The method of claim 1 further including manually selecting the threshold file size.

6. The method of claim 1, wherein the threshold file size is a predetermined default file size.

7. The method of claim 1, wherein the step of selecting is determined by a priority list of communication networks.

8. The method of claim 7, wherein the priority list is formed by an associated user assigning a priority to a plurality of available communication networks.

9. The method of claim 7, wherein when the E-mail message has not been transmitted for a user defined time period, another communication network is selected from the priority list.

10. A mobile telephone comprising:
an electronic mail (E-mail) application stored in a memory of the mobile telephone, wherein the E-mail application is configurable for transmitting an E-mail message in a first mode when the E-mail message has a file size less than a threshold file size and a second mode when the file size of the E-mail message is greater than the threshold file size.
a processor coupled to the E-mail application, wherein the processor compares the file size of the E-mail message with the threshold file size and configures the mobile telephone for communication using the first mode or the second mode.

11. The mobile telephone of claim 10 further including a display coupled to the processor for displaying a status of at least one function associated with the E-mail application.

12. The mobile telephone of claim 10, wherein the associated user selects the threshold file size.

13. The mobile telephone of claim 10, wherein the threshold file size is a predetermined file size.

14. The mobile telephone of claim 10, wherein the first mode is a cellular telephone network.

15. The method of claim 14, wherein the second mode is a local area network.

16. The method of claim 14, wherein the second mode is a wireless local area network.

17. A method for transmitting an electronic mail message in a mobile telephone, the method comprising:
determining a file size of an E-mail message;
selecting a communication network to transmit the E-mail message by an associated user based at least on part on a network priority list stored in a memory of a mobile telephone, wherein the network priority list includes a plurality of networks the file size of the E-mail message, wherein a first communication network is selected when the file size is below a threshold file size and a second communication network is selected when the file size is above the threshold file size; and
transmitting the E-mail message to the selected communications network for delivery to an associated remote E-mail server.

18. A method for receiving an electronic mail message in a mobile telephone, the method comprising:
determining a file size associated with an E-mail message;
selecting a communication network to receive the E-mail message based at least on part on the file size of the E-mail message, wherein a first communication network is selected when the file size is below a threshold file size and a second communication network is selected when the file size is above the threshold file size; and
receiving the E-mail message from an associated remote E-mail server through the selected communications network.

19. A method for transmitting an electronic mail message in a mobile telephone, the method comprising:
determining a file size of an E-mail message;
selecting a communication network to receive the E-mail message by an associated user based at least on part on a network priority list stored in a memory of a mobile telephone, wherein the network priority list includes a plurality of networks the file size of the E-mail message, wherein a first communication network is selected when the file size is below a threshold file size and a second communication network is selected when the file size is above the threshold file size; and
receiving the E-mail message from an associated remote E-mail server through the selected communications network.

20. A method for transmitting an electronic mail message in a mobile telephone, the method comprising:
determining a file size of an E-mail message;
querying an associated user to select a communication network to receive and/or transmit the E-mail message, wherein the associated user may select either a cellular telephone network or a local area network for transmission of the E-mail message;
transmitting the E-mail message through the selected communications network for delivery to an associated remote E-mail server.

21. A computer program stored on a machine readable medium, the program being suitable for use in an electronic equipment as an electronic mail application, wherein:
when the program is loaded in memory in the electronic equipment and executed causes the electronic equipment to transmit and/or receive an E-mail message from a cellular telephone network and/or a local area network based at least in part on the file size of the E-mail message.
